(19) United States
(12) Patent Application Publication
(10) Pub. No.: US 2005/0218978 A1
(43) Pub. Date: Oct. 6, 2005

(54) Freestanding portable electronic devices

(76) Inventors: Alan Liu, Millbrae, CA (US); Xian Fong Liu, Shanghai (CN); Min Gen Cheng, Shanghai (CN)

Correspondence Address: COUDERT BROTHERS LLP, Two Palo Alto Square, 3000 El Camino Real, Palo Alto, CA, 94306, US

(21) Appl. No.: 10/815,302

(22) Filed: Mar. 31, 2004

(51) Int. Cl. H01J 5/00

(52) U.S. Cl. 330/114

(57) ABSTRACT

A portable electronic device is provided including a shell having a front, a back, a right side, a left side, a top, and a bottom having insufficient cross-sectional area to adequately support the shell, a pair of legs having an upper end mounted to the back and a lower end to provide support to allow the shell to be freestanding. An elongated slot is provided on the back of the shell adjacent each of the sides. The slot is capable of receiving each of the legs. An axle and a spring encircling the axle are fixedly attached to the right and left sides of the shell. The upper end of each of the legs is pivotally mounted on each axle placing the spring in a sustained position. A control button is operably connected to a leg lock device mounted within the shell. This enables the user to be able to unlock each of the legs from a stored position within the slots in the back to an extended position at a fixed angle away from the shell under the action of the spring. A gear on an upper end of each leg is engaged with a gear bracket in the shell and allows for a slower movement when control button is pushed causing the legs to rotate out. The leg lock device also retains the legs within the respective slots in the closed position.

### FIELD OF INVENTION

The invention is directed to freestanding portable electronic devices having legs for additional support and more particularly to freestanding thin-bodied amplifiers that are tilted back and supported on legs.

### BACKGROUND OF THE INVENTION

Thin devices, such as personal data assistants (PDA's) and similar portable devices, are often too thin to allow them to be freestanding without some separate means of support. Most often, a separate cradle is used to provide the needed support when the device is not being held by the user. Similar cradles are used to support thin computers, and the like.

One class of such portable devices is thin amplifiers. Typically, thin-bodied amplifiers are mounted into housings, as in car radios. Freestanding amplifiers usually have a sufficient width and thickness to allow the amplifiers to be supported on their bottom surfaces. However, with thin-bodied amplifiers, e.g., having widths in the range of about 9 to 24 inches or less, and thicknesses of less than about three inches, the cross-sectional areas of the bottom surfaces are insufficient to provide adequate support.

There is a need for providing portable electronic devices with extendable and retractable legs to provide adequate support to enable them to be freestanding on the ground, floor, tables and the like.

### SUMMARY OF THE INVENTION

One embodiment of a portable electronic device of the present invention includes a shell having a front, a back, a right side, a left side, a top, and a bottom having insufficient cross-sectional area to adequately support the shell, a pair of legs having an upper end mounted to the back, a lower end to provide support to allow the shell to be freestanding, and an elongated slot on the back of the shell adjacent each of the sides for receiving each of the legs.

In another embodiment of the present invention, a freestanding thin-bodied amplifier has a right leg and a left leg, each leg having an upper end respectively mounted to the back of the shell adjacent to each of the right and left sides. An elongated slot is provided on the back of the shell adjacent each of the right and left sides. The slot is capable of receiving each of the legs. An axle is fixedly attached to the right and left sides of the shell. This enables the user to be able to rotate each of the legs from a stored position within the slots in the back to an extended position at a fixed angle away from the shell. Preferably, this angle is about 45° to provide the greatest stability to the thin-bodied amplifier or other portable device.

### BRIEF DESCRIPTION OF THE DRAWINGS

Further features and advantages will become apparent from the following and more particular description of the preferred embodiment of the invention, as illustrated in the accompanying drawing in which:

FIG. 1 is a perspective view of the front and right side of a portable electronic device with support legs extended;

FIG. 2 is a front view of the embodiment of FIG. 1;

FIG. 3 is a back view of the embodiment of FIG. 1 with the support legs stored in the respective slots formed in the device;

FIG. 4 is a right side view of the embodiment of FIG. 1;

FIG. 5 is a left side view of the embodiment of FIG. 1;

FIG. 6 is a top view of the embodiment of FIG. 1;

FIG. 7 is a bottom view of the embodiment of FIG. 1;

FIG. 8 is a perspective view of the back side of the embodiment of FIG. 1 with the support legs in their fully extended position;

FIG. 9 is a cross-sectional view of half of the right side of the embodiment of FIG. 1 taken along line 3A-3A of FIG. 3with no internal components shown;

FIG. 10 is a cross-sectional view of a portion of the front of the embodiment of FIG. 1 taken along line 5-5 of FIG. 5;

FIG. 11 is a cross-sectional view through a portion of the right side the embodiment of FIG. 1 taken along line 3B-3B of FIG. 3;

FIG. 12 is a photograph of selected internal features of the left side of the embodiment of FIG. 1, looking to the rear, showing the details of the gear of a leg engaged in a gear bracket and the spring in the gear end of the leg;

FIG. 13 is a photograph of selected internal features of the left side of the embodiment of FIG. 1, looking to the rear, showing the details of the leg locking device; and

FIG. 14 is a photograph of selected internal features of the left side of the embodiment of FIG. 1, looking to the rear, showing additional details of the leg locking device shown in FIG. 13.

### DETAILED DESCRIPTION OF THE PRESENT INVENTION

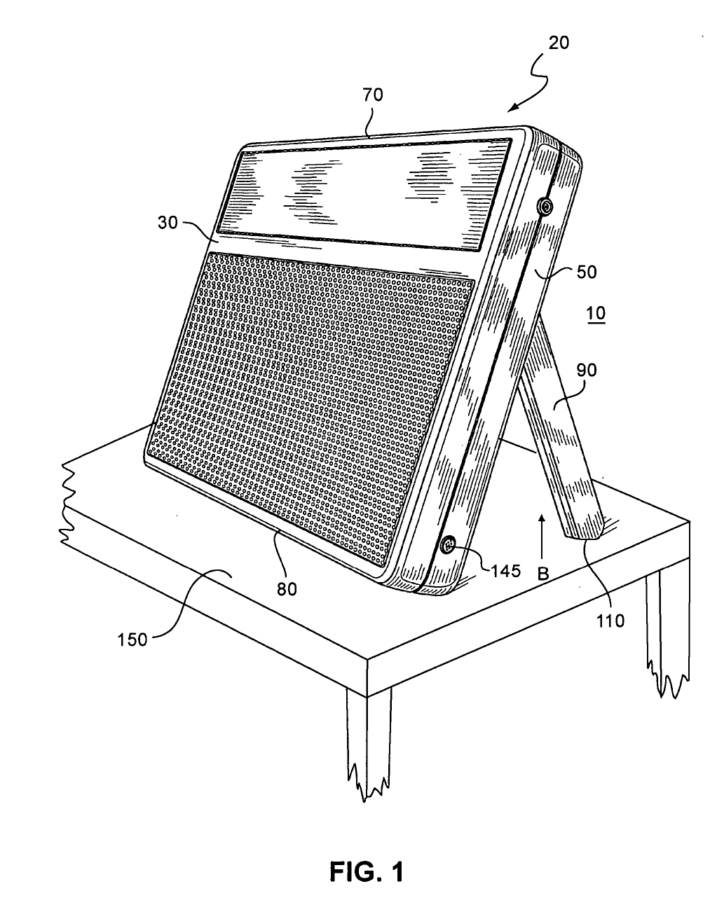

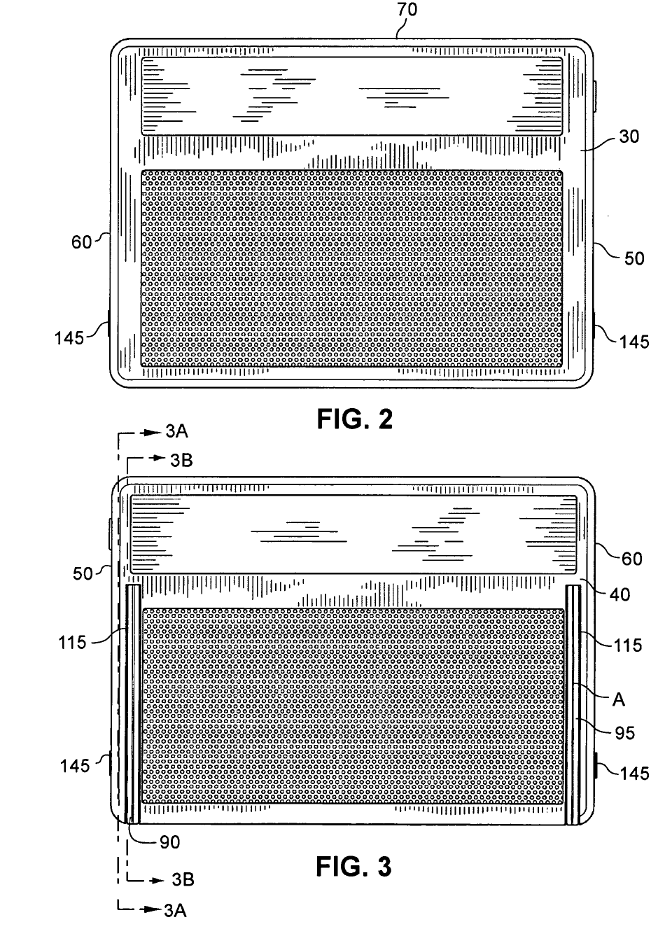

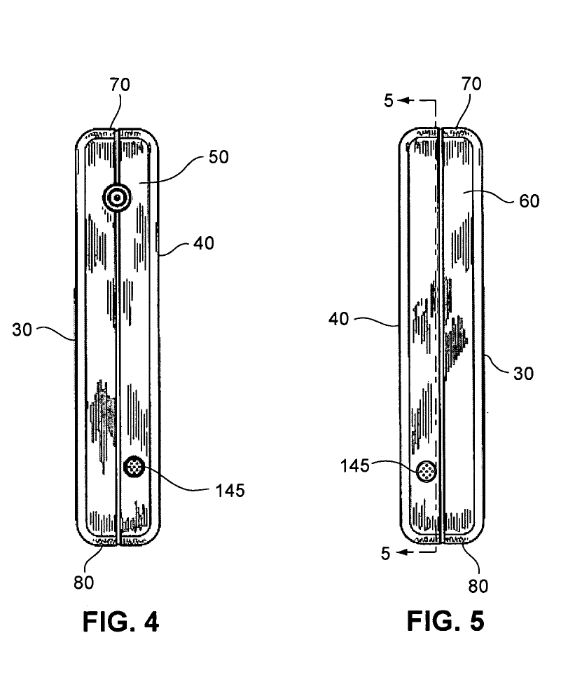

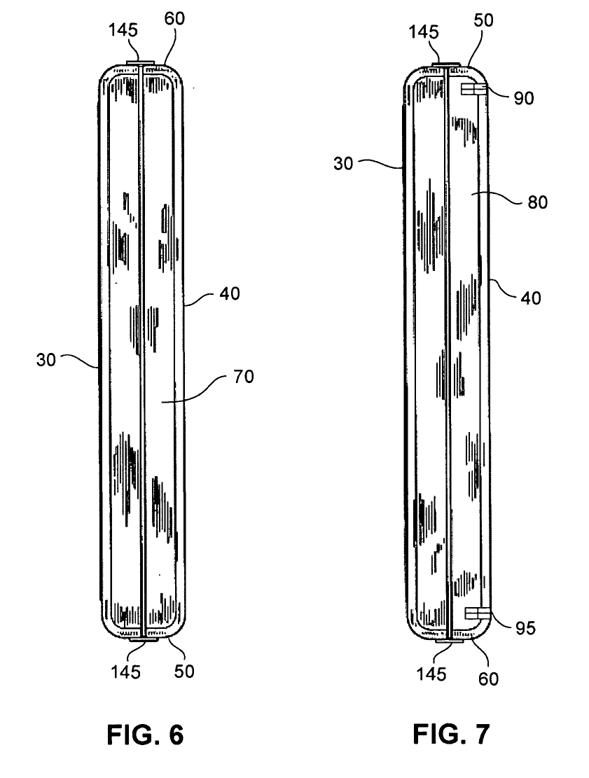

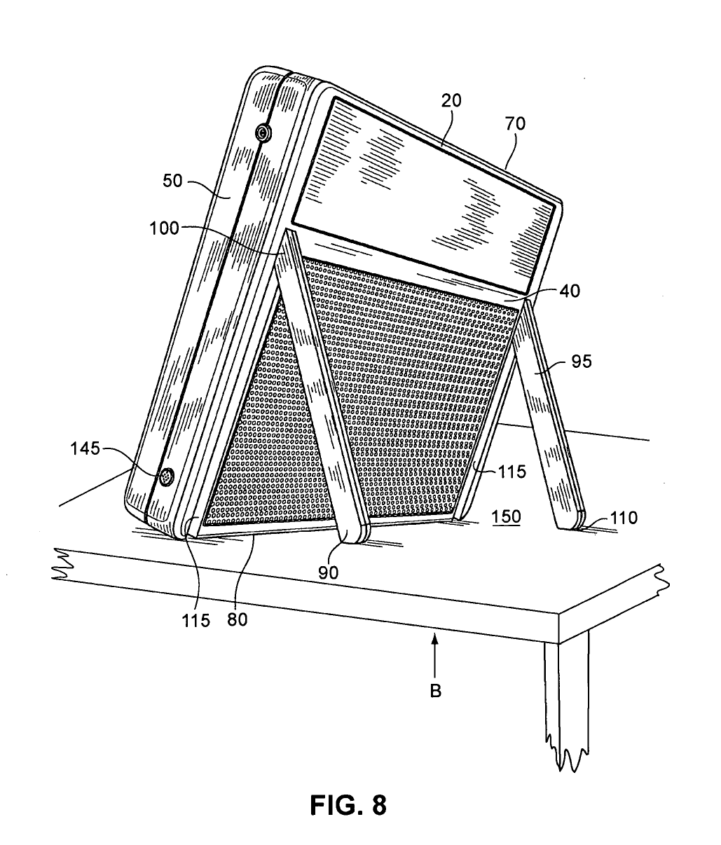

FIGS. 1-8 show various views of one embodiment of the present invention. Freestanding amplifier device 10 includes shell 20 having front 30, back 40, right side 50, right side 60, top 70, and bottom 80; and a pair of legs, i.e., right leg 90 and left leg 95. Each of the legs has upper end 100 mounted to back 40 and lower end 110 that rests on a suitable surface, to provide the necessary additional support to allow the shell to be freestanding. Back 40 has an elongated slot 115 adjacent each of the right and left sides 50 and 60. Slots 115 are sized to receive each of legs 90 and 95 with adequate room as shown in FIG. 3 so as to avoid having to force the legs within slots 115.

Typical dimensions of amplifier 10 of this embodiment include a height in the range of about 12 to 24 inches, a width in the range of about 9 to 24 inches and a thickness in the range of about 1 to 3 inches. The resulting cross-sectional area of bottom 80 is not adequate to support shell 20 without the use of a pair of legs 90 and 95 that extend at an angle from back 40 and are respectively positioned adjacent to the right side 60 and left side 50 as shown in FIG. 3, 7 and 8.

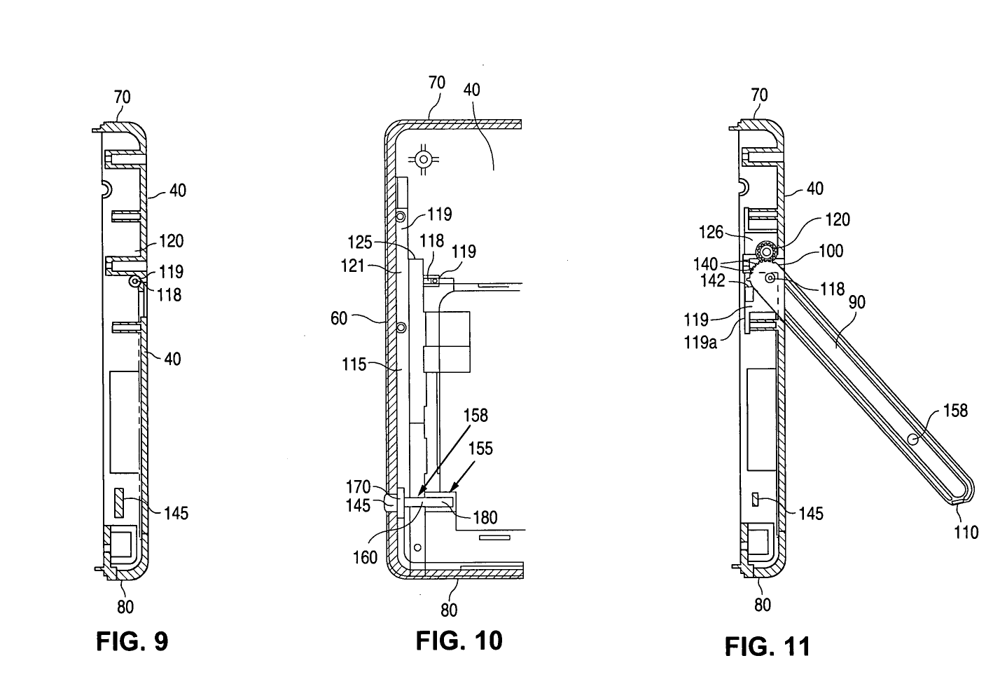

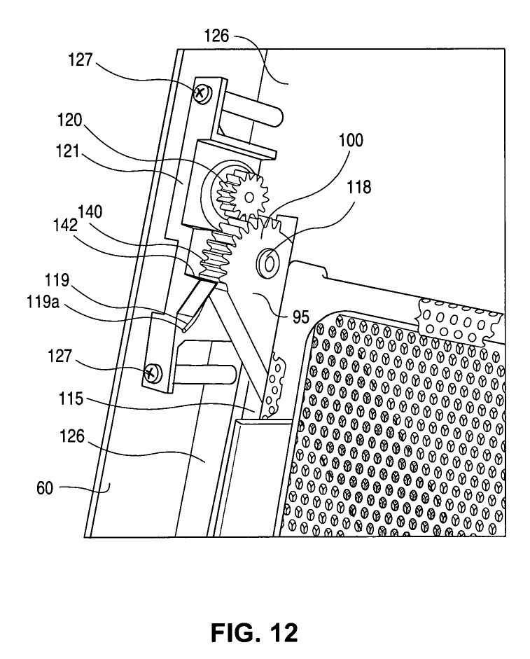

FIG. 9 shows half of right side 50 removed from back 40 along line 3A-3A of FIG. 3 with no internal features of device 10 shown except for one of axles 118 on which is mounted spring 119; see FIG. 12 for additional details of spring 119.

FIG. 10 is a view of about a fourth of back 40 at left side 50 along line 5-5 of FIG. 5. FIG. 10 shows certain of the internal features of device 10 including one of axles 118 and one of slots 115.

FIG. 11 shows half of right side 50 along line 3B-3B of FIG. 3 and shows leg 90 in its fully extended position. FIG. 11 shows leg 90 pivotally mounted on axle 118 and gear bracket 120 mounted to support 121 immediately adjacent upper portion 125 of slot 115. Sustained spring 119 is coiled around axle 118 with one end 119a being fixedly attached to support 121. Support 121 is attached to internal housing 126 by means of bolts 127. Upper end 100 of leg 90 has gear 140 engaged with gear bracket 120 adjacent right side 50. Similarly, leg 95 has gear 140 engaged with gear bracket 120 adjacent left side 60, as shown in FIG. 12.

In operation, as each spring 119 causes its respective leg 90, 95 to extend out from respective slots 115, the teeth of gear 140 rotate towards a surface 142 of support 121. When the teeth of gear 140 on a given leg 90, 95 contact surface 142, further rotation of the leg 90, 95 is prevented. The surface 142 is positioned such that, when each leg 90, 95 contacts a respective surface 142, the legs are preferably extending from the amplifier 10 approximately 45 from the vertical.

FIGS. 1, 2, 4, 8, and 9 show control button 145 mounted on right side 50. Similarly, a control button is mounted on left side 60, as shown in FIG. 10.

Pushing on control button 145 causes legs 90 and 95, respectively, to spring forward from stored position A to extended position B as a result of spring 119.

In extended position B, amplifier 10 is in a tilt back position, preferably at an angle of about 45° with respect to resting surface 150. Although legs 90 and 95 can be mounted to back 40 in a number of ways, the use of gear 140 and gear bracket 120 controls the spring forward motion of the legs. The use of the gears and gear brackets allows for a slower movement of legs 90 and 95 when control button 145 is pushed inward.

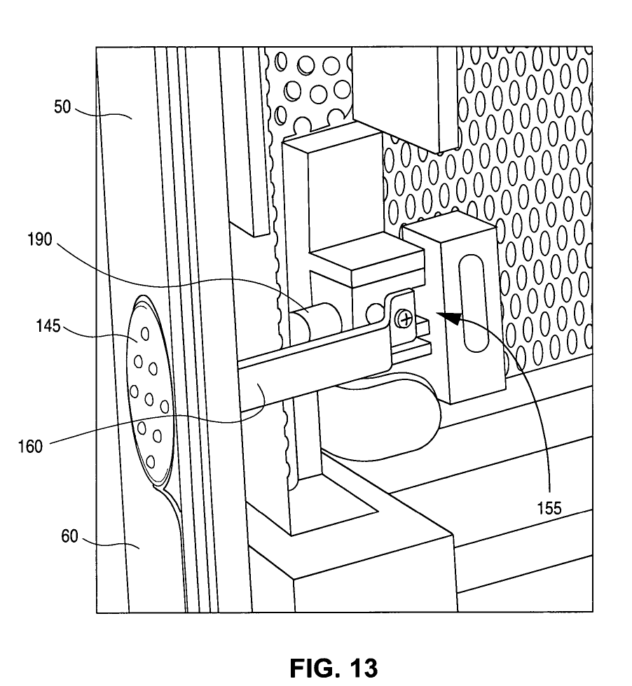

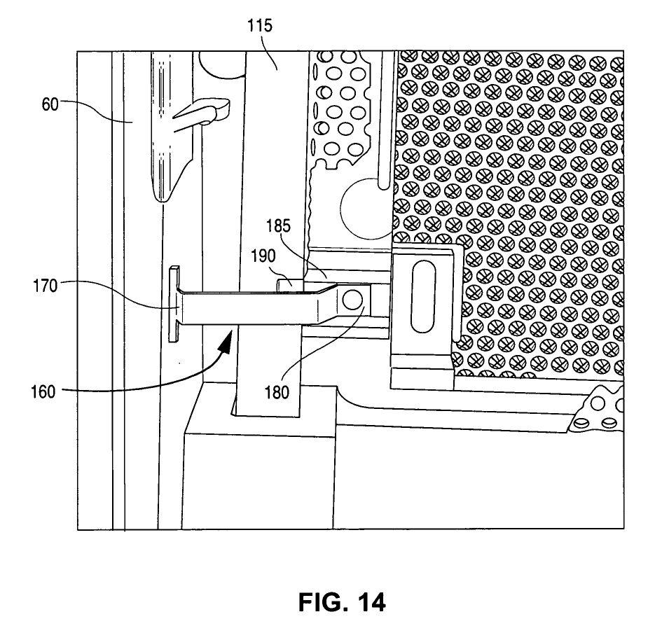

Referring to FIGS. 13-14, leg locking device 155 is shown mounted on left side 50. A corresponding locking device 155 is also mounted on right side 60. Locking device 155 is operated by means of bracket 160 having outside end 170 and inside end 180. The outside end 170 of bracket 160 is connected to each of the respective control buttons 145. The inside end 180 of each bracket 160 is connected to a respective leg locking device 155, so that, when each control button 145 is pushed, each of the associated legs 90 and 95 slowly moves from the stored position A, shown in FIG. 13, to the extended position B, shown in FIG. 1, because of the combined action of gear 120, gear bracket 140, and spring 119. Leg locking devices 155 each include a housing 185 and spindle 190 that is attached to the inside end 180 of bracket 160 The outside end of spindle 190 is positioned within a hole 158 (shown in FIG. 11) in it's associated leg 90, 95 to hold the leg in the stored position A when control button 145 is not being pushed. When each of the control buttons 145 is pushed inwardly, spindle 190 is moved inwardly within housing 185. This in turn releases each of the legs 90 and 95. In their retracted position A, each of the legs 90 and 95 have been pushed within the respective slots 115 to move spindles 190 until the hole 158 is aligned with the outside end of spindle 190. This allows the outside end of spindle 190 to enter each of holes 158 to lock legs 90 and 95 in place.

Without departing from the spirit and scope of this invention, one of ordinary skill in the art can make various changes and modifications to the device of the present invention to adapt it to various usages and conditions. As such, these changes and modifications are properly, equitably, and intended to be, within the full range of equivalents of the following claims.

1. An electronic device (10) comprising a shell (20) having a front (30), a back (40), a right side (50), a left side (60), a top (70), and a bottom (80) having insufficient cross-sectional area to adequately support said shell, a pair of legs (90) having an upper end (100) mounted to the back and a lower end (110) to provide support to allow said shell to be freestanding, the back having an elongated slot (115) adjacent each of the right and left sides and shaped to receive one of said legs and an axle (118) fixedly attached to the right and left sides to enable each of said legs to rotate from a stored position (A) within said slots in the back to an extended position (B).

2. The electronic device of claim 1, wherein a spring (119) is mounted on each of said axles (118) to cause each of said legs to rotate out from said slots.

3. A freestanding amplifier (10) comprising a shell (20) having a front (30), a back (40), a right side (50), a left side (60), a top (70), and a bottom (80) having insufficient cross-sectional area to adequately support said shell, a right leg (90) and a left leg 95, each leg having an upper end (100) respectively mounted to the back of the shell adjacent to each of the right and left sides and a lower end (110) to provide support to allow said shell to be freestanding, the back having an elongated slot (115) adjacent each of the right and left sides and shaped to receive one of said legs and an axle (118) fixedly attached to the right and left sides to enable each of said legs to rotate from a stored position (A) within said slots in the back to an extended position (B).

4. The amplifier of claim 2, wherein a spring (119) is mounted on each of said axles (118) to cause each of said legs to rotate out from said slots.

5. The amplifier of claim 4, wherein a gear bracket (120) is mounted to the back adjacent each of the right and left sides, the upper end of each of the legs has a gear (140) engageable with the respective gear brackets, and a control button (145) on each the right and left sides for allowing each of the legs to move from a stored position (A) within said slots to an extended position (B) as a result of the combined action of said spring and said gear and gear bracket and to place the amplifier in a tilt back position with respect to a resting surface (150).

6. The amplifier of claim 2, wherein the lower end (110) of each leg rests flat against the resting surface (150).

7. The amplifier of claim 5 wherein a leg locking device (155) is mounted on the back adjacent to each of said right and left sides, each of said legs has a hole (158) adjacent the lower end (110), a bracket (160) has an outside end (170) and an inside end (180), the outside end (170) of which is connected to each of the respective control buttons (145) and the inside end (180) of which is connected to each of the respective spindles (190) so that when the button is pushed in each of said legs slowly move from the stored position (A) to the extended position (B) by the action of said spring.

8. The amplifier of claim 7 wherein each of said leg locking devices (155) comprises:
(a) a housing (185) within the back of said shell;
(b) said bracket (160); and
(b) said spindle (190) having an outside end within a hole (158) when each of said legs (90 and 95) are in the stored position (A), and an inside end attached to the inside end (180) of said bracket (160); so that when each of said control buttons (145) is pushed inwardly, said spindle is moved inwardly within the housing causing the outside end of said spindle (190) to move from the hole to release each of said legs (90 and 95) to open position (B) as a result of the action of said spring, and when each of said legs (90 and 95) are pushed within the respective slots 115, the legs rotate on the respective axles compressing each of the springs (119) until the hole (158) is aligned with the outside end of the spindle to cause the outside end to enter each of the holes during the stored position (A).
